(19) United States
(12) Patent Application Publication
(10) Pub. No.: US 2013/0078596 A1
(43) Pub. Date: Mar. 28, 2013

(54) APPARATUS FOR DETECTING BONE DEFECTS AND DENTAL ABUTMENT THEREOF

(71) Applicants: Min-Chun PAN, Taoyuan County (TW); Han-Bo ZHUANG, Kaohsiung City (TW); Chao-Ping LEE, Taoyuan County (TW)

(72) Inventors: Min-Chun PAN, Taoyuan County (TW); Han-Bo ZHUANG, Kaohsiung City (TW); Chao-Ping LEE, Taoyuan County (TW)

(73) Assignee: NATIONAL CENTRAL UNIVERSITY, TAOYUAN COUNTY (TW)

(21) Appl. No.: 13/334,080

(22) Filed: Dec. 22, 2011

(30) Foreign Application Priority Data
Sep. 22, 2011 (TW) 100134181

(51) Int. Cl. A61C 19/04; A61C 8/00

(52) U.S. Cl. 433/27

(57) ABSTRACT

An apparatus for detecting bone defects includes a detecting device and a dental abutment wirelessly connected to each other. The dental abutment includes a vibration component, at least one vibration excitation transducer, and at least one response sensor. The vibration component is used for being inserted in a dental implant. The vibration excitation transducer is disposed at one side of the vibration component for exciting the vibration component to vibrate, and the vibration excitation transducer is spatially separated from the vibration component. The response sensor is disposed at a side of the to vibration component opposite to the vibration excitation transducer for detecting the vibration of the vibration component.

### RELATED APPLICATIONS

This application claims priority to Taiwan Application Serial Number 100134181, filed Sep. 22, 2011, which is herein incorporated by reference.

### BACKGROUND

1. Technical Field

The present disclosure relates to a detecting apparatus. More particularly, the present disclosure relates to an apparatus for detecting bone defects, and relates also to a dental abutment of the apparatus.

2. Description of Related Art

Along with the overall development in technology, medical apparatuses and related techniques are progressing day by day. Dental implantations have become a common dental surgical technique. Currently, there are two types of dental implantation depending on the dental implant type and surgical method, and they include immediate implantation and two-stage implantation. In immediate implantation, a part of the dental implant is exposed outside the gingiva after the dental implant is implanted in the alveolus bone, after which the crown of a tooth can be disposed in the dental implant. In two-stage implantation, the dental implant is entirely covered in the gingiva, and the crown of a tooth is disposed by making an incision in the gingiva after osseointegration. As a result, in the case of two-stage implantation, the excitation from the environment to the dental implant and the alveolus bone can be alleviated, and the probability of infection can be reduced during the period of osseointegration, so that the dental implant can be fixed in the alveolus bone more stably.

When the dental implant is implanted, the bone newly formed can tightly contact the dental implant when the bone tissue is healed, such that good stability between the dental implant and the bone tissue can be achieved. This process is referred to as osseointegration. Generally speaking, about six months are required for the alveolus bone of the palate to realize an acceptable level of osseointegration, and about three or four months are required for the alveolus bone of the mandible.

The stability of the dental implant plays a very important role in the implantation. The better the osseointegration that takes place, the higher the stability of the dental implant that can be achieved, and thus, implantation surgery can be accomplished more easily. Therefore, evaluating the stability of a dental implant is an important procedure that must be performed, preferably both during and after implantation surgery.

Using current techniques, the stability of a dental implant is determined utilizing vibration. This method is effective and not destructive. However, only the overall stability near the boundary between the dental implant and the alveolus bone can be determined using such a method, and the positions of irregular bone defects when the stability is poor cannot be precisely detected. Further, X-ray detection commonly utilized in a dental clinic may be used to obtain only plane images, that is, two-dimensional images, and the positions of bone defects and the osseointegration of the dental implant cannot be effectively determined. Thus, current techniques to detect the stability of dental implants is lacking for a variety of reasons.

### SUMMARY

In view of the foregoing, an apparatus for detecting bone defects and a dental abutment of the apparatus are provided in the following disclosure.

In an aspect of the present invention, an apparatus for detecting bone defects is disclosed. The apparatus for detecting bone defects includes a detecting device and a dental abutment wirelessly connected to each other.

The dental abutment includes a vibration component, at least one vibration excitation transducer, and at least one response sensor. The vibration component is used for being inserted in a dental implant. The vibration excitation transducer is disposed at one side of the vibration component for exciting the vibration component to vibrate. The vibration excitation transducer is spatially separated from the vibration component. The response sensor is disposed at a side of the vibration component opposite to the vibration excitation transducer for detecting the vibration of the vibration component.

In another aspect of the present invention, a dental abutment for detecting bone defects is disclosed. The dental abutment of the present invention includes a vibration component, at least one vibration excitation transducer, and at least one response sensor. The vibration component is used for being inserted in a dental implant. The vibration excitation transducer is disposed at one side of the vibration component for exciting the vibration component to vibrate. The vibration excitation transducer is spatially separated from the vibration component. The response sensor is disposed at a side of the vibration component opposite to the vibration excitation transducer for detecting the vibration of the vibration component.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic view of an apparatus for detecting bone defects in accordance with an embodiment of the present invention;

FIG. 2 is a schematic view of the apparatus in FIG. 1 after a dental abutment is inserted in a dental implant;

FIG. 3 is a schematic view of the apparatus in FIG. 1 after the dental abutment is inserted in the dental implant in a manner different from FIG. 2;

FIG. 4a is a top view of the first embodiment of the dental abutment of the present invention;

FIG. 4b is a top view of the second embodiment of the dental abutment of the present invention;

FIG. 4c is a top view of the third embodiment of the dental abutment of the present invention;

FIG. 4d is a top view of the fourth embodiment of the dental abutment of the present invention;

FIG. 5 is a top view of the fifth embodiment of the dental abutment of the present invention;

FIG. 6 is a block diagram of the dental abutment in accordance with an embodiment of the present invention; and

FIG. 7 is a block diagram of a detecting device in accordance with an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In general, one embodiment of the present invention provides an apparatus for detecting bone defects and a dental abutment of the apparatus. The apparatus for detecting bone defects in accordance with the embodiments of the present invention may detect the stability of a dental implant and the positions of bone defects around the dental implant in a noninvasive and nondestructive manner. The dental abutment for detecting bone defects in accordance with an embodiment of the present invention can be exposed outside the gingiva for primary stability detection. The dental abutment can also be covered in the gingiva for secondary stability detection, thereby alleviating the discomfort caused by making an incision in the gingiva when detecting stability. Thus, one embodiment of the present invention can be applied to both immediate implantation and two-stage implantation. It should be noted that the shapes and dimensions disclosed in the following description may be modified or varied depending on the patient because the oral cavity of each person is unique. Hence, the present invention is not limited to the shapes and dimensions disclosed in the following description and the accompanying drawings.

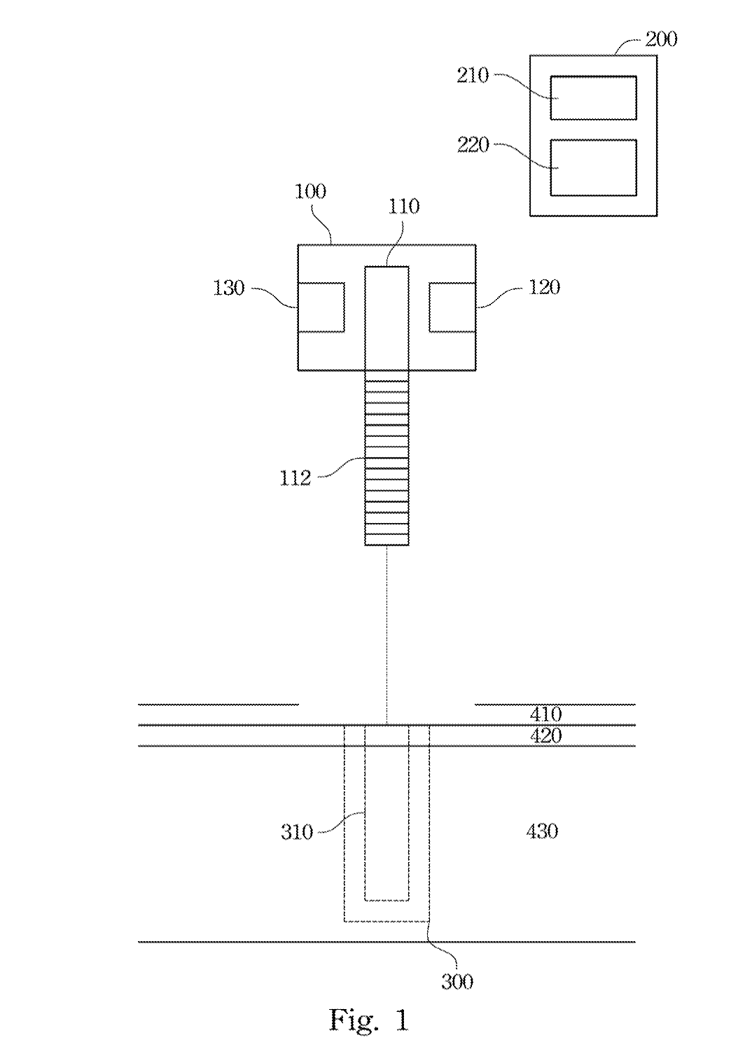

FIG. 1 is a schematic view of the apparatus for detecting bone defects in accordance with an embodiment of the present invention. The apparatus for detecting bone defects includes a detecting device 200 and a dental abutment 100 wirelessly connected to each other. The dental abutment 100 includes a vibration component 110, a vibration excitation transducer 120, and a response sensor 130. The vibration component 110 is inserted in a dental implant 300. The vibration excitation transducer 120 is disposed at one side of the vibration component 110 for exciting the vibration component 110. The vibration excitation transducer 120 is not physically contacted with the vibration component 110. Stated differently, the vibration excitation transducer is spatially separated from the vibration component 110. The response sensor 130 is disposed at a side of the vibration component 110 opposite to the vibration excitation transducer 120. The response sensor 130 detects the vibration of the vibration component 110.

Through the aforementioned configuration, the vibration excitation transducer 120 disclosed in the embodiment of the present invention generates non-contacted vibration excitation, such as a sound wave, a magnetic force, or the like, to excite the vibration component 110, so that the dental implant 300 and the alveolus bone around the vibration component 110 can be excited. The response sensor 130 disposed at a side of the vibration component 110 opposite to the vibration excitation transducer 120 then detects a vibration response and a displacement variation. The detecting result of the response sensor 130 can be analyzed by the detecting device 200 to obtain the resonant frequency and the displacement variation, so that bone defects can be detected more precisely.

In this embodiment, the response sensor 130 is spatially separated from the vibration component 110. For example, the response sensor 130, which is spatially separated from the vibration component 110, may include, but is not limited to, a capacity-type displacement sensor, a doppler velocity sensor, or a ultrasonic sensor.

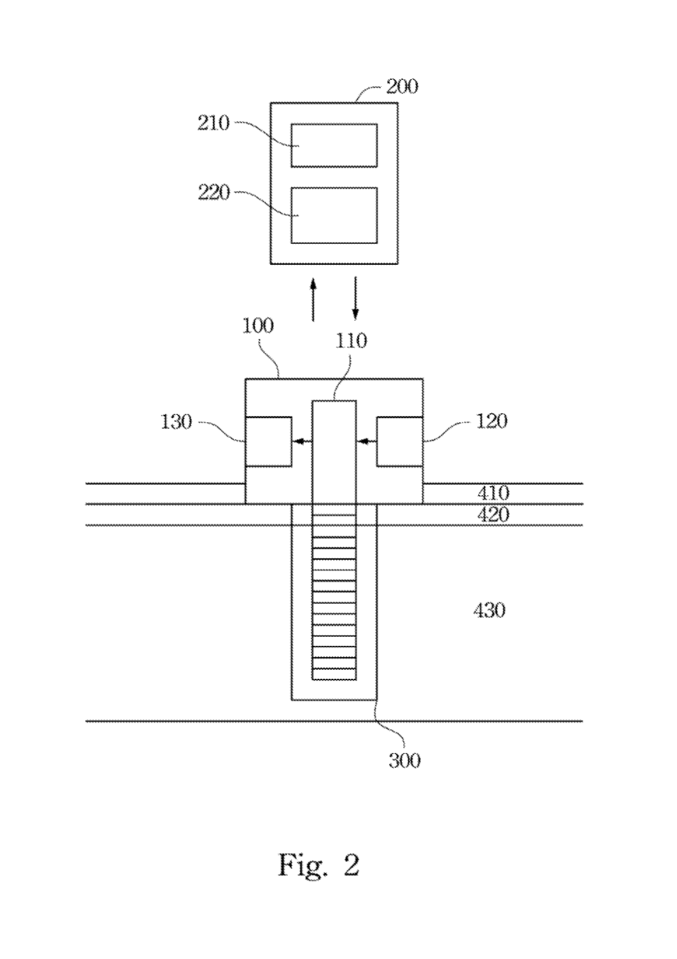

FIG. 2 is a schematic view of the apparatus in FIG. 1 after the dental abutment is inserted in the dental implant. As shown in FIG. 2, the vibration component 110 is inserted in the dental implant 300, such that the dental abutment 100 is fixed on the gingiva 410. The dental implant 300 is surrounded by the alveolus bone, which includes the alveolar cortical bone 420 and the alveolar cancellous bone 430 as shown in FIG. 2. Because the vibration component 110 is tightly attached in the dental implant 300, the dental implant 300 vibrates when the vibration excitation transducer 120 excites the vibration component 110. As described above, the vibration excitation transducer 120 excites the vibration component 110 without physical contact, that is, through the use of sound waves, a magnetic force, or the like. Through such operation, the vibration of the vibration component 110 detected by the response sensor 130 can be regarded as the vibration of the dental implant 300, thereby enabling the positions of bone defects to be determined. Additionally, because the dental abutment 100 is exposed outside the gingiva 410, it can be used to evaluate primary stability.

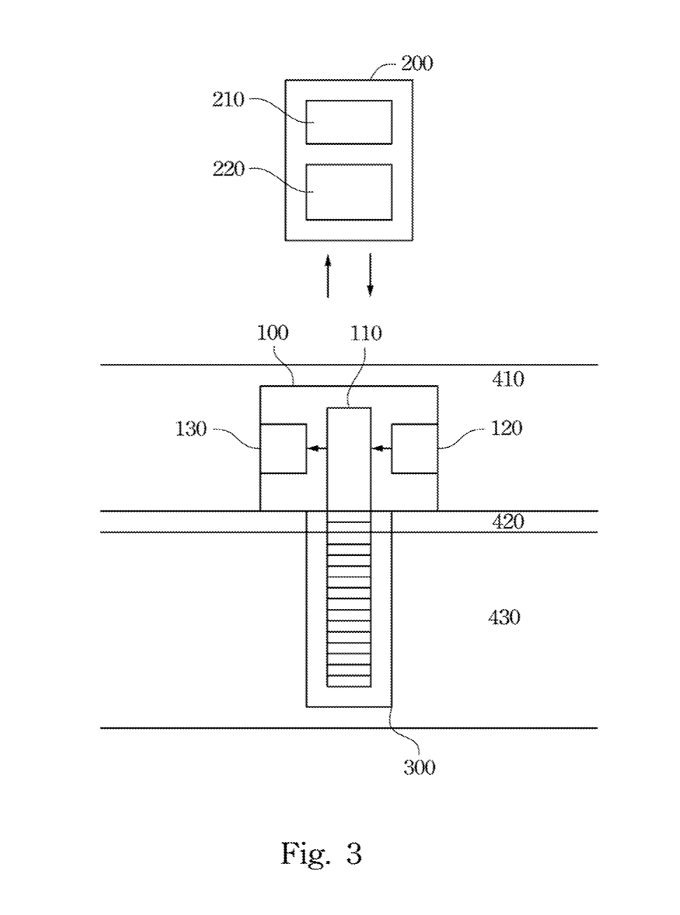

FIG. 3 is a schematic view of the apparatus in FIG. 1 after the dental abutment is inserted in the dental implant in a manner different from FIG. 2. The main difference between the arrangement shown in FIG. 3 and that shown in FIG. 2 is that the dental abutment 100 is covered in the gingiva 410, so that the apparatus for detecting bone defects can be used in evaluating secondary stability. As shown in FIG. 3, the vibration component 110 is inserted in the dental implant 300, such that the dental abutment 100 can be fixed in the gingiva 410. As shown in FIG. 3 and similar to arrangement appearing in FIG. 2, the dental implant 300 is surrounded by the alveolus bone, which includes the alveolar cortical bone 420 and the alveolar cancellous bone 430. Because the vibration component 110 is tightly attached to the dental implant 300, the dental implant 300 vibrates when the vibration excitation transducer 120 excites the vibration component 110 without physical contact, that is, using sound waves, a magnetic force, or the like. Through such operation, the vibration of the vibration component 110 detected by the response sensor 130 can be regarded as the vibration of the dental implant 300, thereby enabling the positions of bone defects to be determined.

In accordance with one or more embodiments of the present invention, one vibration excitation transducer 120 and one response sensor 130 are arranged in a manner diametrically opposed to each other and separated by the vibration component 110. Further, in some embodiments, pairs of the vibration excitation transducers 120 and the response sensors 130 may surround the vibration component 110 in different orientations. As a result, the vibration response and the displacement of the vibration component 110 can be detected using different orientations, thereby allowing the positions of bone defects to be more precisely determined.

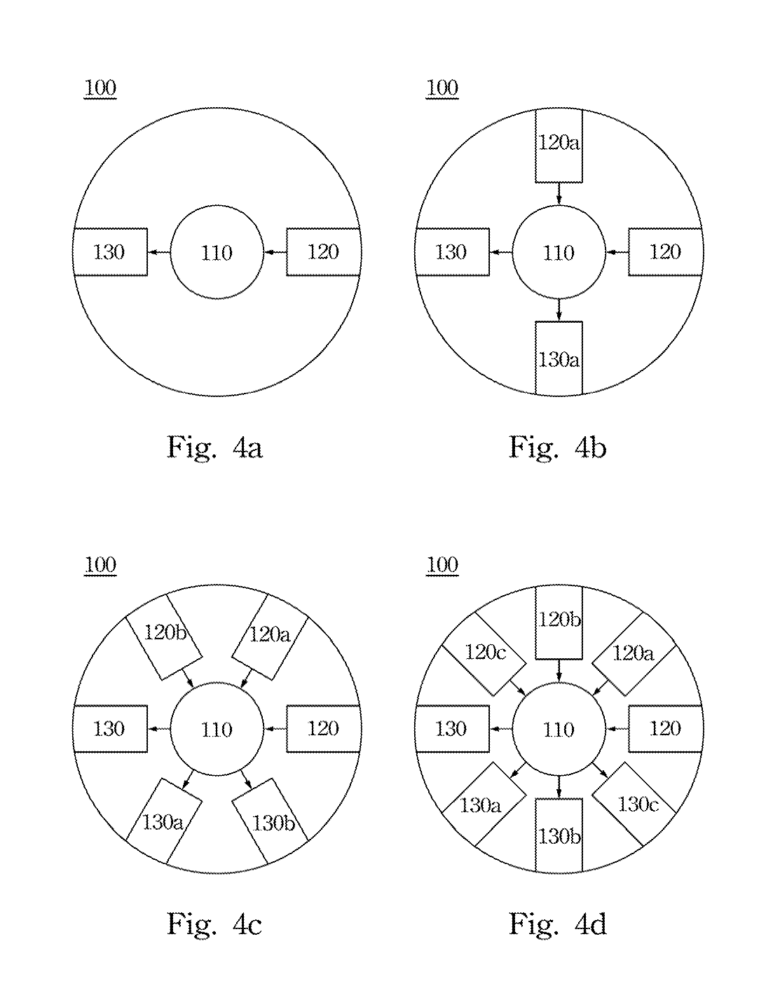

FIG. 4a is a top view of a first embodiment of the dental abutment of the present invention. As shown in FIG. 4a, the dental abutment 100 comprises one vibration excitation transducer 120 and one response sensor 130, which are disposed at opposite sides of the vibration component 110. In other words, the vibration excitation transducer 120 and the response sensor 130 are arranged in a diametrically opposed configuration and are separated by the vibration component 110. In some embodiments, the vibration excitation transducer 120, the response sensor 130, and the center of the vibration component 110 are aligned along a straight line, so as to enable the response sensor 130 to more directly detect the vibration of the vibration component 110 excited by the vibration excitation transducer 120.

FIG. 4b is a top view of a second embodiment of the dental abutment of the present invention. As shown in FIG. 4b, the dental abutment 100 includes two vibration excitation transducers 120, 120a and two response sensors 130, 130a. In this case, the vibration excitation transducer 120 and the response sensor 130 are disposed at opposite sides of the vibration component 110, and the vibration excitation transducer 120a and the response sensor 130a are disposed at other opposite sides of the vibration component 110 in an orientation orthogonal to the orientation of the vibration excitation transducer 120 and the response sensor 130. In other words, the vibration excitation transducer 120, the center of the vibration component 110, and the response sensor 130 are aligned along a straight line, so as to enable the response sensor 130 to detect the vibration of the vibration component 110 excited by the vibration excitation transducer 120 more directly. Similarly, the vibration excitation transducer 120a, the center of the vibration component 110, and the response sensor 130a are also aligned along a straight line, so as to enable the response sensor 130a to detect the vibration of the vibration component 110 excited by the vibration excitation transducer 120a more directly. By the aforementioned configuration, the response sensors 130 and 130a can detect the vibration response and the displacement variation in different orientations, so as to allow the positions of bone defects to be determined more precisely.

FIG. 4c is a top view of a third embodiment of the dental abutment of the present invention. As shown in FIG. 4c, the dental abutment 100 includes three vibration excitation transducers 120, 120a, and 120b and three response sensors 130, 130a, and 130b disposed surrounding the vibration component 110. In other words, the vibration excitation transducers 120, 120a, and 120b are respectively arranged in a manner diametrically opposed to the response sensors 130, 130a, and 130b, in which each of the vibration excitation transducers 120, 120a or 120b and the corresponding response sensor 130, 130a or 130b are separated by the vibration component 110. As in the case of FIG. 4a and FIG. 4b, the response sensors 130, 130a, and 130b can respectively detect the vibration response and the displacement variation in different orientations, so that the positions of bone defects can be more precisely determined.

FIG. 4d is a top view of a fourth embodiment of the dental abutment of the present invention. As shown in FIG. 4d, the dental abutment 100 includes four vibration excitation transducers 120, 120a, 120b, and 120c and four response sensors 130, 130a, 130b, and 130 disposed surrounding the vibration component 110. Similar to the configuration shown in FIG. 4c, the vibration excitation transducers 120, 120a, 120b, and 120c are respectively arranged in a manner diametrically opposed to the response sensors 130, 130a, 130b, and 130c in which each of the vibration excitation transducers 120, 120a, 120b, or 120c and the corresponding response sensor 130, 130a, 130b or 130c are separated by the vibration component 110. Therefore, the response sensors 130, 130a, 130b, and 130c may respectively detect the vibration response and the displacement variation in different orientations, so that the positions of bone defects can be more precisely determined.

In addition to the aforementioned embodiments, the dental abutment may further include N pairs of vibration excitation transducers and response sensors (N is an integer greater than 1), so as to detect the positions of bone defects in more orientations. N can be varied depending on detection requirements.

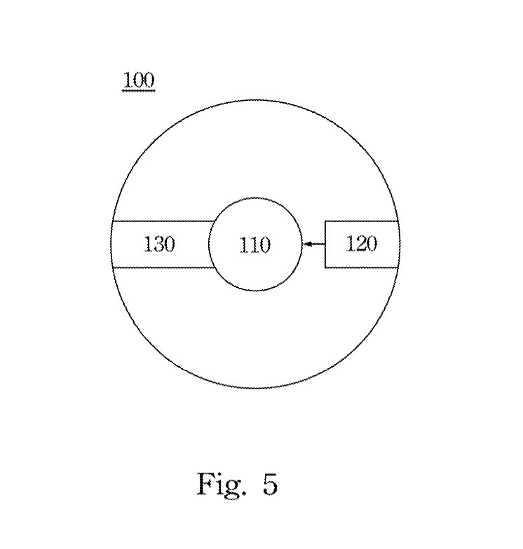

FIG. 5 is a top view of a fifth embodiment of the dental abutment of the present invention. In this embodiment, the dental abutment 100 includes one vibration component 110, one vibration excitation transducer 120, and one response sensor 130. The main difference between the embodiment and the dental abutment 100 shown in FIG. 1 is that the response sensor 130 is disposed at one side of the vibration component 110 in a manner making physical contact with the same. In this embodiment, the response sensor 130 in physical contact with the vibration component 110 may include, but is not limited to, an accelerometer, or a fiber optic strain sensor. However, similar to FIG. 1, the vibration excitation transducer 120 is disposed at an opposite side of the vibration component 110 without making physical contact with the same. In this embodiment, the vibration excitation transducer 120 is disposed at one side of the vibration component 110 for exciting the vibration component 110, and the response sensor 130 is in contact with the vibration component 110 opposite to the vibration excitation transducer 120 in order to detect the vibration of the vibration component 110. Specifically, the vibration excitation transducer 120 and the response sensor 130 are arranged in a diametrically opposed configuration and are separated by the vibration component 110. In some embodiments, the vibration excitation transducer 120, the response sensor 130, and the center of the vibration component 110 are aligned along a straight line, so as to enable the response sensor 130 to more directly detect the vibration of the vibration component 110 excited by the vibration excitation transducer 120.

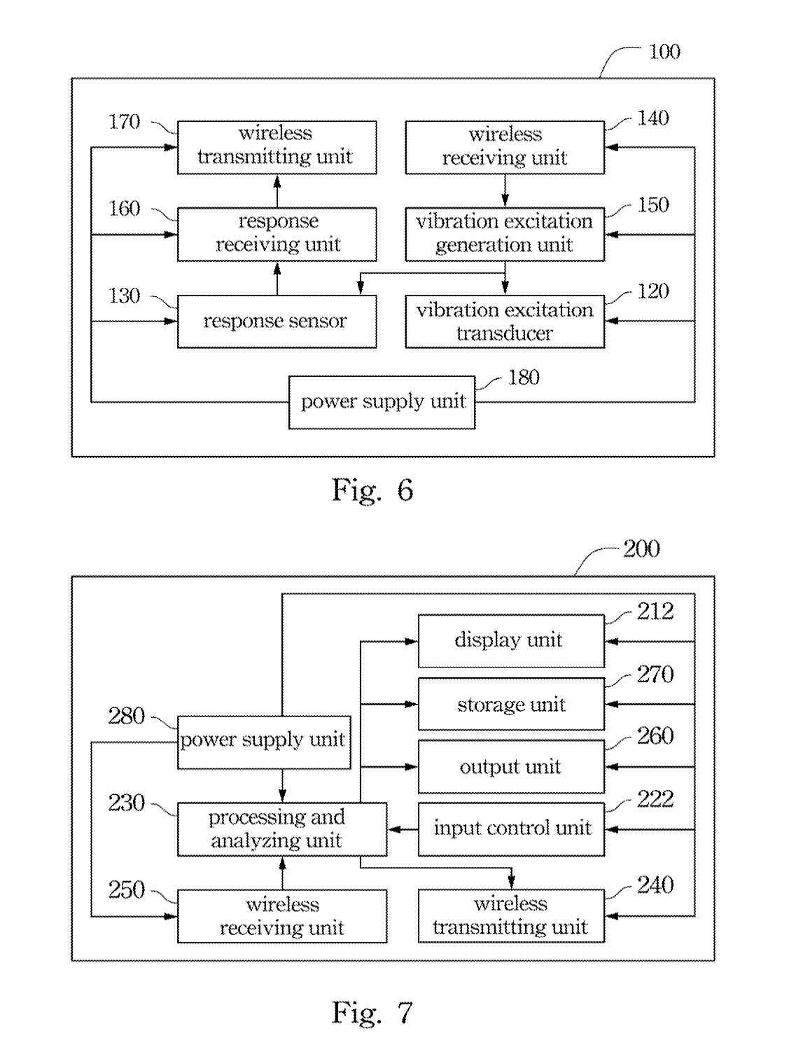

FIG. 6 is a block diagram of the dental abutment in accordance with an embodiment of the present invention. As shown in FIG. 6, the dental abutment 100 includes the vibration excitation transducer 120, the response sensor 130, a wireless receiving unit 140, a vibration excitation generation unit 150, a response receiving unit 160, a wireless transmitting unit 170, and a power supply unit 180.

In this embodiment, the wireless receiving unit 140 is used for receiving the wireless transmitting signals from the detecting device 200 (see FIG. 2 or FIG. 3) and to transfer the signals to the vibration excitation generation unit 150.

The vibration excitation generation unit 150 is used for operating the vibration excitation transducer 120 and the response sensor 130 in a manner corresponding to the wireless transmission signals. For example, the vibration excitation generation unit 150 may transmit digital signals to the vibration excitation transducer 120 and the response sensor 130, so as to operate these devices, thereby initiating the non-contacted excitation (e.g., through the use of sound waves, a magnetic force, or the like) and detecting the vibration response.

The response receiving unit 160 is used for receiving the detecting results from the response sensor 130, in which the detecting results includes the vibration response and the displacement variation detected by the response sensor 130.

The wireless transmitting unit 170 is used for transmitting the detecting results, which are received from the response sensor 130 by the response receiving unit 160, to the detecting device 200 (see FIG. 2 or FIG. 3). Specifically, the wireless transmitting unit 170 can generate a wireless transmission signal to transmit the detecting results of the response sensor 130 to the detecting device 200.

The power supply unit 180 is used for providing power for the vibration excitation transducer 120, the response sensor 130, the wireless receiving unit 140, the vibration excitation generation unit 150, the response receiving unit 160, and the wireless transmitting unit 170. In some embodiments, when the power supply unit 180 is low on power, the wireless transmitting unit 170 may transmit a wireless transmitting signal to the detecting device 200 (see FIG. 2 or FIG. 3), so as to inform the user to replace the power supply unit 180 or charge the power supply unit 180 using wireless charging technology. In some embodiments, the power supply unit 180 may be charged using mechanical energy that has been transformed into electric energy. For example, mechanical energy derived from oral motion (e.g., biting, chewing, or grinding) may be transformed into electric energy. In this embodiment, the wireless transmitting and receiving signals may include, but are not limited to including, RF signals, ultrasonic wave signals, microwave signals, Bluetooth® signals, and so on.

FIG. 7 is a block diagram of the detecting device in accordance with an embodiment of the present invention. As shown in FIG. 7, the detecting device 200 includes a display unit 212, an input control unit 222, a processing and analyzing unit 230, a wireless transmitting unit 240, a wireless receiving unit 250, an output unit 260, a storage unit 270, and a power supply unit 280.

In this embodiment, the wireless receiving unit 250 is used for receiving the detecting results from the response sensor 130 (see FIG. 2 or FIG. 3).

In some embodiments, an input control panel 220 (see FIG. 1, FIG. 2, or FIG. 3) can be disposed on the exterior of the detecting device 200, so that the user can operate the detecting device 200 and input commands via the input control panel 220.

The input control unit 222 is used for receiving the commands from the detecting device 200. Moreover, the input control unit 222 may transfer the commands to be executed to the processing and analyzing unit 230, so as to control relevant units to perform corresponding functions.

The processing and analyzing unit 230 is used for analyzing the detecting results from the response sensor 130. In other words, the processing and analyzing unit 230 may compute and analyze the vibration response and the displacement variation detected by the response sensor 130, thereby obtaining the resonant frequency and determining the positions of bone defects. In an embodiment, such as that is shown is FIG. 4d, the response sensors 130, 130a, 130b, and 130c may obtain different response and displacement variation because they detect the response in different orientations, and the processing and analyzing unit 230 may compute and analyze the difference between responses and displacement variations obtained from these response sensors 130, 130a, 130b, and 130c, thereby obtaining the positions of bone defects. The wireless transmitting unit 240 is used for transmitting wireless transmitting signals to the dental abutment 100 (see FIG. 2 or FIG. 3), so as to control the operation of the vibration excitation transducer 120 and the response sensor 130.

The display unit 212 is used for rendering the analysis results of the processing and analyzing unit 230. In some embodiments, the display 210 (see FIG. 1, FIG. 2, or FIG. 3) is disposed on the exterior of the detecting device 200, and the display unit 212 may transfer the analysis results to the display 210 for rendering.

The storage unit 270 is used for storing the analysis results of the processing and analyzing unit 230. In some embodiments, the storage unit 270 may transfer the analysis results to the memory of the detecting device 200, such as a flash memory or RAM (random access memory) thereof.

The output unit 260 is used for outputting the analysis results of the processing and analyzing unit 230. In some embodiments, the output unit 260 may transmit the analysis results to a peripheral device, such as a computer, a mobile phone, etc.

The power supply unit 280 is used for providing electric power for the display unit 212, the input control unit 222, the processing and analyzing unit 230, the wireless transmitting unit 240, the wireless receiving unit 250, the output unit 260, and the storage unit 270. In some embodiments, power may be supplied to the power supply unit 280 via an adaptor or a USB (universal serial bus) connector connected to an external device. When there is an insufficient amount of power, the display 210 may show a particular icon to inform the user to charge or replace the power supply unit 280.

Referring back to FIG. 1, in this embodiment, an outer screw thread 112 is formed on the surface of part of the vibration component 110 protruding from the dental abutment 100, and an inner screw thread 310 is formed on the surface of the dental implant 300. The outer screw thread 112 is compatible with the inner screw thread 310, so that the vibration component 110 can be screwed into the dental implant 300. As a result, the dental abutment 100 can be fixed. Additionally, in some embodiments, when the vibration excitation transducer 120 generates a sound wave, the frequency may range from 20 to 20000 Hz. In other embodiments, when the vibration excitation transducer 120 generates a magnetic force, the intensity and polarity may be varied based on applied current. The vibration component 110 may be made of a polymer material or a biocompatible metal when it is excited by a sound wave. Alternatively, the vibration component 110 may be made of polarized magnetic material when it is excited by a magnetic force.

In some embodiments, the dental abutment 100 may be made of a polymer material or a biocompatible metal. The biocompatible material may include, but is not limited to including, titanium or an alloy thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An apparatus for detecting bone defects comprising:
a detecting device; and
a dental abutment wirelessly connected to the detecting device, the dental abutment comprising:
a vibration component for being inserted in a dental implant;
at least one vibration excitation transducer disposed at one side of the vibration component for exciting the vibration component to vibrate, wherein the vibration excitation transducer is spatially separated from the vibration component; and
at least one response sensor disposed at a side of the vibration component opposite to the vibration excitation transducer for detecting the vibration of the vibration component.

2. The apparatus for detecting bone defects of claim 1, wherein the response sensor is spatially separated from the vibration component.

3. The apparatus for detecting bone defects of claim 1, wherein a plurality of the vibration excitation transducers are respectively arranged in a manner diametrically opposed to a plurality of the response sensors, and each of the vibration excitation transducers and the corresponding response sensor are separated by the vibration component.

4. The apparatus for detecting bone defects of claim 3, wherein each of the vibration excitation transducers, the corresponding response sensor, and a center of the vibration component are aligned along a straight line.

5. The apparatus for detecting bone defects of claim 1, wherein the vibration excitation transducer generates a sound wave or a magnetic force to excite the vibration component to vibrate.

6. The apparatus for detecting bone defects of claim 5, wherein the vibration component is made of a polymer material or a biocompatible metal when the vibration excitation transducer generates a sound wave.

7. The apparatus for detecting bone defects of claim 5, wherein the vibration component is made of a polarized magnetic material when the vibration excitation transducer generates a magnetic force.

8. The apparatus for detecting bone defects of claim 1, wherein the dental abutment is made of a polymer material or a biocompatible metal.

9. The apparatus for detecting bone defects of claim 1, wherein the dental abutment is screwed in the dental implant.

10. The apparatus for detecting bone defects of claim 1, wherein the dental abutment comprises:
a wireless receiving unit for receiving wireless transmitting signals from the detecting device;
a vibration excitation generation unit for operating the vibration excitation transducer and the response sensor corresponding to the wireless transmitting signals;
a response receiving unit for receiving detecting results from the response sensor; and
a wireless transmitting unit for transmitting the detecting results to the detecting device.

11. The apparatus for detecting bone defects of claim 1, wherein the detecting device comprises:
a wireless receiving unit for receiving detecting results from the response sensor;
a processing and analyzing unit for analyzing the detecting results from the response sensor; and
a wireless transmitting unit for transmitting wireless transmitting signals to the dental abutment.

12. A dental abutment for detecting bone defects comprising:
a vibration component for being inserted in a dental implant;
at least one vibration excitation transducer disposed at one side of the vibration component for exciting the vibration component to vibrate, wherein the vibration excitation transducer is spatially separated from the vibration component; and
at least one response sensor disposed at a side of the vibration component opposite to the vibration excitation transducer for detecting the vibration of the vibration component.

13. The dental abutment for detecting bone defects of claim 12, wherein the response sensor is spatially separated from the vibration component.

14. The dental abutment for detecting bone defects of claim 12, wherein the response sensor is physically contacted with the vibration component.

15. The dental abutment for detecting bone defects of claim 12, a plurality of the vibration excitation transducers are respectively arranged in a manner diametrically opposed to a plurality of the response sensors, and each of the vibration excitation transducers and the corresponding response sensor are separated by the vibration component.

16. The dental abutment for detecting bone defects of claim 15, wherein each of the vibration excitation transducers, the corresponding response sensor, and a center of the vibration component are aligned along a straight line.

17. The dental abutment for detecting bone defects of claim 12, wherein the vibration excitation transducer generates a sound wave or a magnetic force to excite the vibration component to vibrate.

18. The dental abutment for detecting bone defects of claim 12, wherein the vibration component is made of a polymer material or a biocompatible metal when the vibration excitation transducer generates a sound wave.

19. The dental abutment for detecting bone defects of claim 12, wherein the vibration component is made of a polarized magnetic material when the vibration excitation transducer generates a magnetic force.

20. The dental abutment for detecting bone defects of claim 12, further comprising:
a wireless receiving unit for receiving wireless transmitting signals from a detecting device;
a vibration excitation generation unit for operating the vibration excitation transducer and the response sensor corresponding to the wireless transmitting signals;
a response receiving unit for receiving detecting results from the response sensor; and
a wireless transmitting unit for transmitting the detecting results to the detecting device.
